(19) United States
(12) Patent Application Publication
(10) Pub. No.: US 2026/0073345 A1
(43) Pub. Date: Mar. 12, 2026

(54) WIRELESS TAG COMMUNICATION APPARATUS AND WIRELESS TAG COMMUNICATION METHOD

(71) Applicant: Toshiba Tec Kabushiki Kaisha, Tokyo (JP)

(72) Inventors: Nanami SHINOZAKI, Sunto Shizuoka (JP); Hiroyuki ISHIKAWA, Sunto Shizuoka (JP)

(21) Appl. No.: 19/228,302

(22) Filed: Jun. 4, 2025

(30) Foreign Application Priority Data
Sep. 9, 2024 (JP) 2024-154861

(51) Int. Cl. G06Q 10/0833; G06K 7/10

(52) U.S. Cl. CPC G06Q 10/0833; G06K 7/10366

(57) ABSTRACT

According to an embodiment, a wireless tag communication apparatus checks an identification code of a wireless tag read by a reading device against a box list that is a list of identification codes of wireless tags attached to shipping boxes to identify a shipping box to which the wireless tag read by the reading device is attached. Further, the wireless tag communication apparatus creates a shipping list that is a list of the identification code of the wireless tag attached to the identified shipping box and identification codes of wireless tags attached to articles put in the shipping box.

### CROSS-REFERENCE TO RELATED APPLICATIONS

This application is based upon and claims the benefit of priority from the prior Japanese Patent Application No. 2024-154861, filed on September 9, 2024, the entire contents of which are incorporated herein by reference.

### FIELD

An embodiment to be described here generally relates to a wireless tag communication apparatus and a wireless tag communication method.

### BACKGROUND

In recent years, wireless tags have been increasingly used to perform accounting processing, inspection processing, and the like. In such a system, a wireless tag is attached to an article or a product and a wireless tag communication apparatus detects the wireless tag to read information from the wireless tag. The wireless tag transmits, upon receiving a radio wave from the wireless tag communication apparatus, a radio wave in response thereto. The wireless tag communication apparatus emits a radio wave from an antenna and receives, by the antenna, the radio wave transmitted from the wireless tag in response thereto, thereby detecting the wireless tag to read the information from the wireless tag.

Further, the wireless tag communication apparatus transmits/receives radio waves while changing the relative position of the antenna to the wireless tag, and reads information from the wireless tag at a plurality of relative positions of the antenna to the wireless tag, thereby inferring the disposed region of the wireless tag. As a method of inferring the disposed region of the wireless tag, a method based on the phase difference that is a change in phase, a method using a trained model by machine learning, and the like are known.

For example, in the inspection processing for shipping, it is usually necessary to take out a product from a warehouse or the like, put it in a shipping box, and create a shipping list that is a list of the shipping box and products.

### BRIEF DESCRIPTION OF THE DRAWINGS

FIG. 1 is a block diagram showing a configuration example of a wireless tag communication apparatus according to an embodiment.

FIG. 2 is a diagram showing a configuration example of a relative position change device shown in FIG. 1.

FIG. 3 is a diagram showing another configuration example of the relative position change device shown in FIG. 1.

FIG. 4 is a diagram showing still another configuration example of the relative position change device shown in FIG. 1.

FIG. 5 is a diagram showing a hardware configuration of a computer constituting a reading device, an inferring device, the relative position change device, and a terminal shown in FIG. 1.

FIG. 6 is a flowchart showing a first operation example of the wireless tag communication apparatus according to the embodiment.

FIG. 7 is a diagram schematically showing an operation example of the wireless tag communication apparatus shown in FIG. 6.

FIG. 8 is a flowchart showing an operation example of read processing shown in FIG. 6.

FIG. 9 is a flowchart showing an operation example of inference processing shown in FIG. 6.

FIG. 10 is a flowchart showing another operation example of the inference processing shown in FIG. 6.

FIG. 11 is a flowchart showing an operation example of cross-check processing shown in FIG. 6.

FIG. 12 is a flowchart showing an operation example of terminal processing shown in FIG. 6.

FIG. 13 is a flowchart showing a second operation example of the wireless tag communication apparatus according to the embodiment.

FIG. 14 is a diagram schematically showing an operation example of the wireless tag communication apparatus shown in FIG. 13.

FIG. 15 is a flowchart showing an operation example of first read processing shown in FIG. 13.

FIG. 16 is a flowchart showing an operation example of first cross-check processing shown in FIG. 13.

FIG. 17 is a flowchart showing an operation example of second read processing shown in FIG. 13.

### DETAILED DESCRIPTION

According to an embodiment, a wireless tag communication apparatus includes: an antenna; a reading device; and a cross-check device. The antenna receives a radio wave transmitted from a wireless tag. The reading device reads, on a basis of the radio wave received by the antenna, tag data including an identification code of the wireless tag. The cross-check device checks the identification code of the wireless tag read by the reading device against a box list that is a list of identification codes of wireless tags attached to shipping boxes to identify a shipping box to which the wireless tag read by the reading device is attached. Further, the cross-check device creates a shipping list that is a list of the identification code of the wireless tag attached to the identified shipping box and identification codes of wireless tags attached to articles put in the shipping box.

An embodiment will be describe below with reference to the drawings. In the drawings, the same reference symbols denote the same or similar portions. In each drawing, the configuration is omitted or simplified as appropriately in some cases for the sake of description.

### (Wireless tag communication apparatus)

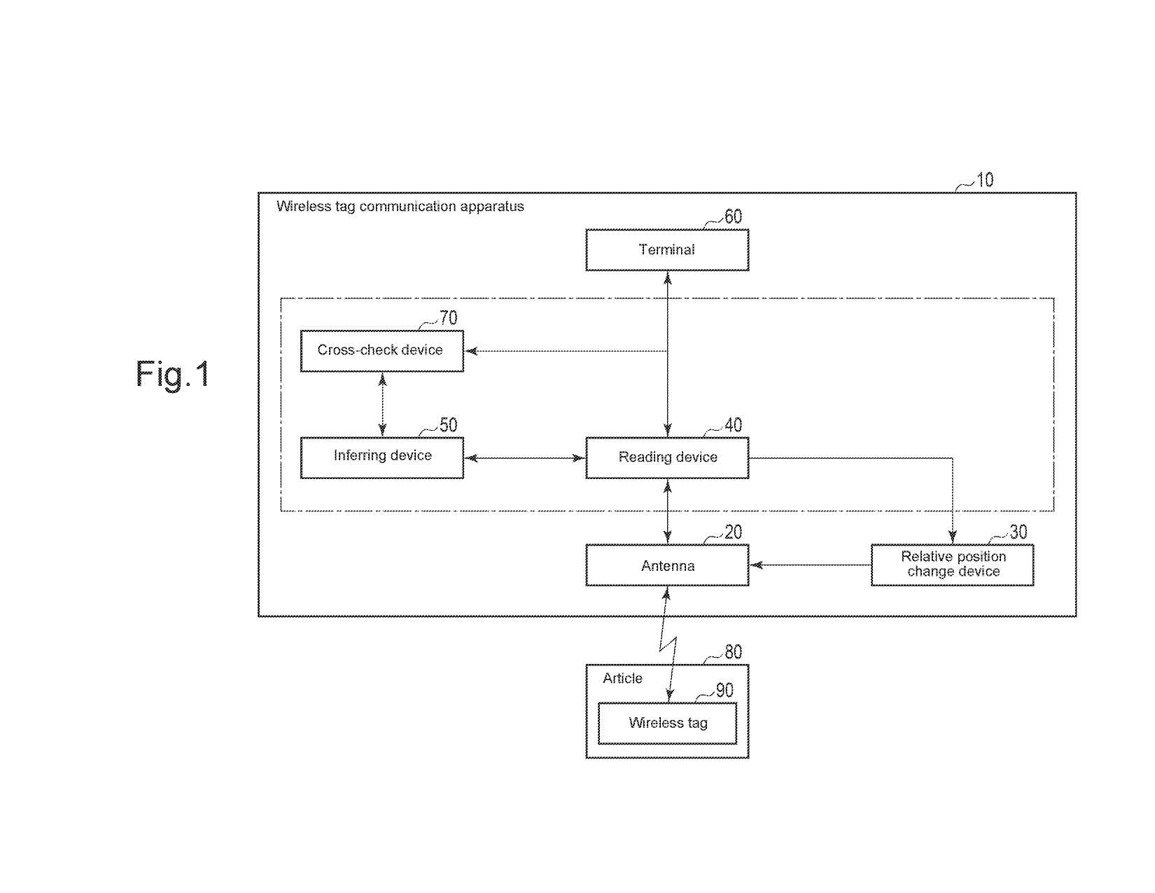

A wireless tag communication apparatus 10 according to an embodiment will be described first with reference to FIG. 1. FIG. 1 is a block diagram showing a configuration example of the wireless tag communication apparatus 10 according to the embodiment.

The wireless tag communication apparatus 10 reads tag data from a wireless tag 90 attached to an article 80 such as a product and a shipping box, infers the disposed region of the wireless tag 90 from the read tag data, and performs processing according to the use on each wireless tag 90 in the inferred disposed region. For example, the wireless tag communication apparatus 10 identifies a shipping box and a product put in the shipping box, and creates a shipping list that is a list of the shipping box and products.

FIG. 1 shows one article 80 and one wireless tag 90 for the sake of convenience, but this is not intended to indicate the number of articles 80 and the number of wireless tags 90. The number of articles 80 and the number of wireless tags 90 may each be one or more, and are often more than one. One wireless tag 90 is attached to one article 80.

The wireless tag communication apparatus 10 includes an antenna 20, a relative position change device 30, a reading device 40, an inferring device 50, a terminal 60, and a cross-check device 70.

The antenna 20 is a device for communicating with the wireless tag 90. The antenna 20 emits a radio wave. Further, the antenna 20 receives a radio wave transmitted from the wireless tag 90 in response to the emitted radio wave. The antenna 20 converts the radio wave received from the wireless tag 90 into a high frequency signal and outputs the high frequency signal to the reading device 40.

The relative position change device 30 changes the relative position of the antenna 20 to the wireless tag 90. The configuration example of the relative position change device 30 will be described below.

The reading device 40 controls the antenna 20 and the relative position change device 30 to read, on the basis of the radio wave that is transmitted from the wireless tag 90 and received by the antenna 20, the tag data including the identification code of the wireless tag 90. In detail, the reading device 40 read the tag data of the wireless tag 90 at a plurality of relative positions of the antenna 20 to the wireless tag 90.

The inferring device 50 infers the disposed region of the wireless tag 90 from the tag data of the wireless tag 90 at the plurality of relative positions of the antenna 20 to the wireless tag 90 read by the reading device 40. The inferring device 50 infers, for one disposed region, for example, whether the wireless tag 90 is in the disposed region or outside the disposed region. The number of disposed regions is not limited to one. That is, the inferring device 50 may infer, for a plurality of disposed regions, whether the wireless tag 90 is in the disposed regions or outside the disposed regions. The inferring device 50 performs the inference using a trained model by machine learning or on the basis of the phase difference of the received radio wave, for example.

The terminal 60 is a device that is an interface with a user (i.e., user interface). The terminal 60 receives a user's instruction for the wireless tag communication apparatus 10. The terminal 60 presents the user with the processing result of the wireless tag communication apparatus 10, for example, the reading result of the reading device 40 or the inference result of the inferring device 50.

Further, the terminal 60 processes the reading result of the reading device 40 and the inference result of the inferring device 50. In one example, the terminal 60 is a cash register terminal for performing accounting processing. Further, in another example, the terminal 60 a mobile terminal to be used for picking when performing inspection processing. The present technology is not limited thereto, and the terminal 60 may be an arbitrary terminal for processing the reading result of the reading device 40 and the inference result of the inferring device 50 in accordance with the intended use.

The cross-check device 70 checks the identification code of the wireless tag 90 inferred to be in disposed region by the inferring device 50 against a box list to identify the shipping box in the disposed region, and creates a shipping list. The box list is a list of identification codes of the wireless tags 90 attached to shipping boxes and is given to the cross-check device 70 in advance. The shipping list is a list of the identification code of the wireless tag 90 attached to the identified shipping box and identification codes of the wireless tags 90 attached to the products put in the shipping box. For example, the shipping list is a list of identification codes of the wireless tags inferred to be in the disposed region by the inferring device 50.

Further, for example, the cross-check device 70 deletes, from the box list, the identification code of the wireless tag 90 that matches the identification code of the wireless tag 90 inferred to be in the disposed region. Further, the cross-check device 70 performs warning processing in the case where it has failed to identify the shipping box. For example, the cross-check device 70 instructs the terminal 60 to perform the warning.

Further, the terminal 60 processes the cross-check result of the cross-check device 70. For example, the terminal 60 displays the shipping list created by the cross-check device 70. Further, the terminal 60 performs the warning upon receiving the warning instruction from the cross-check device 70.

The article 80 is, for example, a product displayed in a store for sale, a product that is preserved in warehouse or the like before shipping or after delivery during distribution, or a shipping box or the like in which the product is put. The present technology is not limited thereto, and the article 80 may be an arbitrary article that is managed using the wireless tag 90.

The wireless tag 90 is, for example, a radio frequency identification (RFID) tag. The present technology is not limited thereto, and the wireless tag 90 may be another wireless tag. For example, the wireless tag 90 is a passive wireless tag that operates using the radio wave transmitted from the antenna 20 as its energy source. The wireless tag 90 transmits a signal including the tag data stored in the wireless tag 90 by performing backscatter modulation on an unmodulated signal. The tag data stored in the wireless tag 90 includes identification tag data that can be uniquely identified. For example, the tag data stored in the wireless tag 90 includes the identification code of the article 80 (product or shipping box) to which the wireless tag 90 is attached.

### (Configuration example of relative position change device)

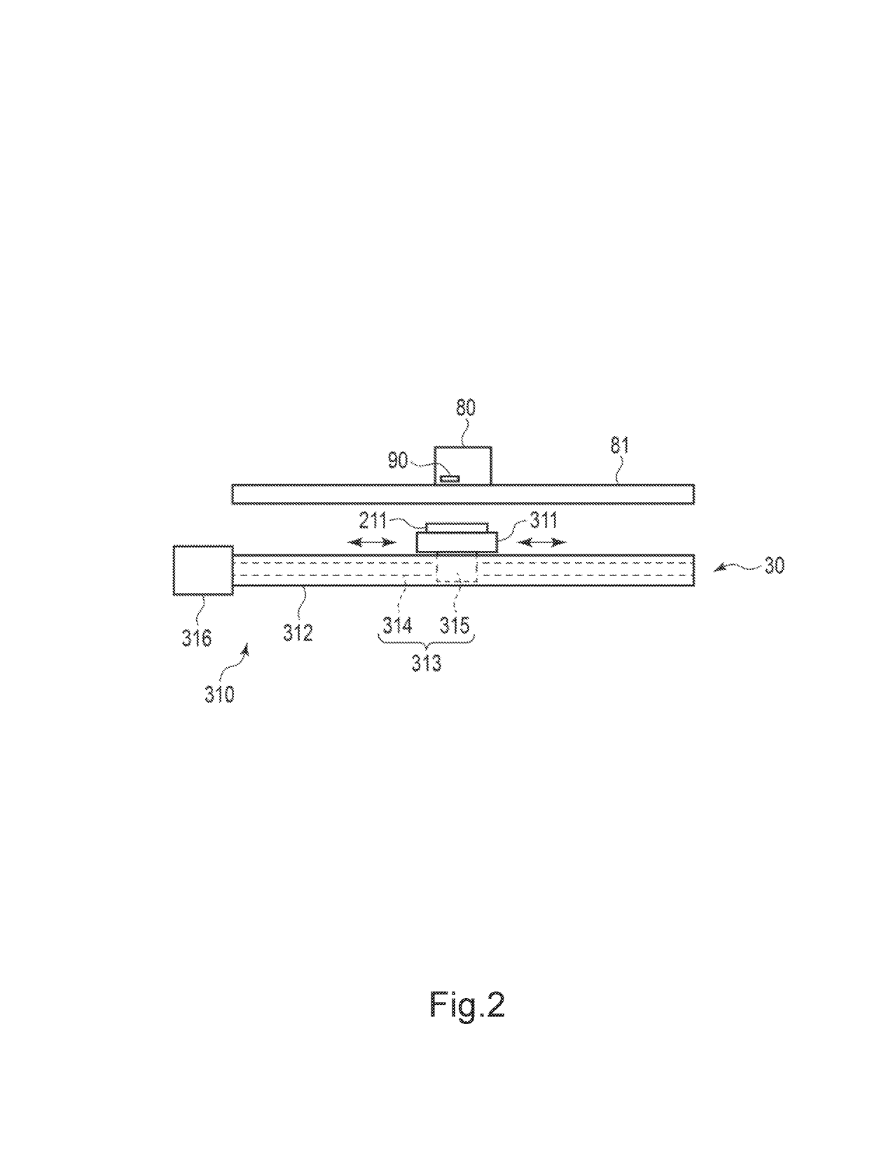

Next, a configuration example of the relative position change device 30 will be described with reference to FIG. 2. FIG. 2 is a diagram showing a configuration example of the relative position change device 30 of the wireless tag communication apparatus 10.

In the configuration example of the relative position change device 30 shown in FIG. 2, the antenna 20 includes one antenna 211. The antenna 20 is installed below a table 81 on which the article 80 to which the wireless tag 90 is attached is placed.

The relative position change device 30 includes a moving mechanism 310 that causes the antenna 211 to move. The moving mechanism 310 is a linear motion mechanism that causes the antenna 211 to linearly move. The moving mechanism 310 includes a stage 311, a guide rail 312, and a driving device 316. The stage 311 holds the antenna 211. The guide rail 312 holds the stage 311 such that the stage 311 is capable of moving linearly. The guide rail 312 includes a ball screw 313 inside. The ball screw 313 includes a rotatable screw shaft 314 and a nut 315 that is capable of moving along the screw shaft 314 in conjunction with the rotation of the screw shaft 314. The nut 315 holds the stage 311. The driving device 316 causes the screw shaft 314 to rotate. The rotational movement of the screw shaft 314 is converted into linear movement of the nut 315. For this reason, when the driving device 316 causes the screw shaft 314 to move, the antenna 211 held by the stage 311 is caused to move linearly.

The driving device 316 is controlled by the reading device 40. The driving device 316 is, for example, a stepping motor. The reading device 40 controls the change in relative position of the antenna 211 to the wireless tag 90, i.e., linear movement, by controlling the stepping motor that is the driving device 316.

### (Another configuration example of relative position change device)

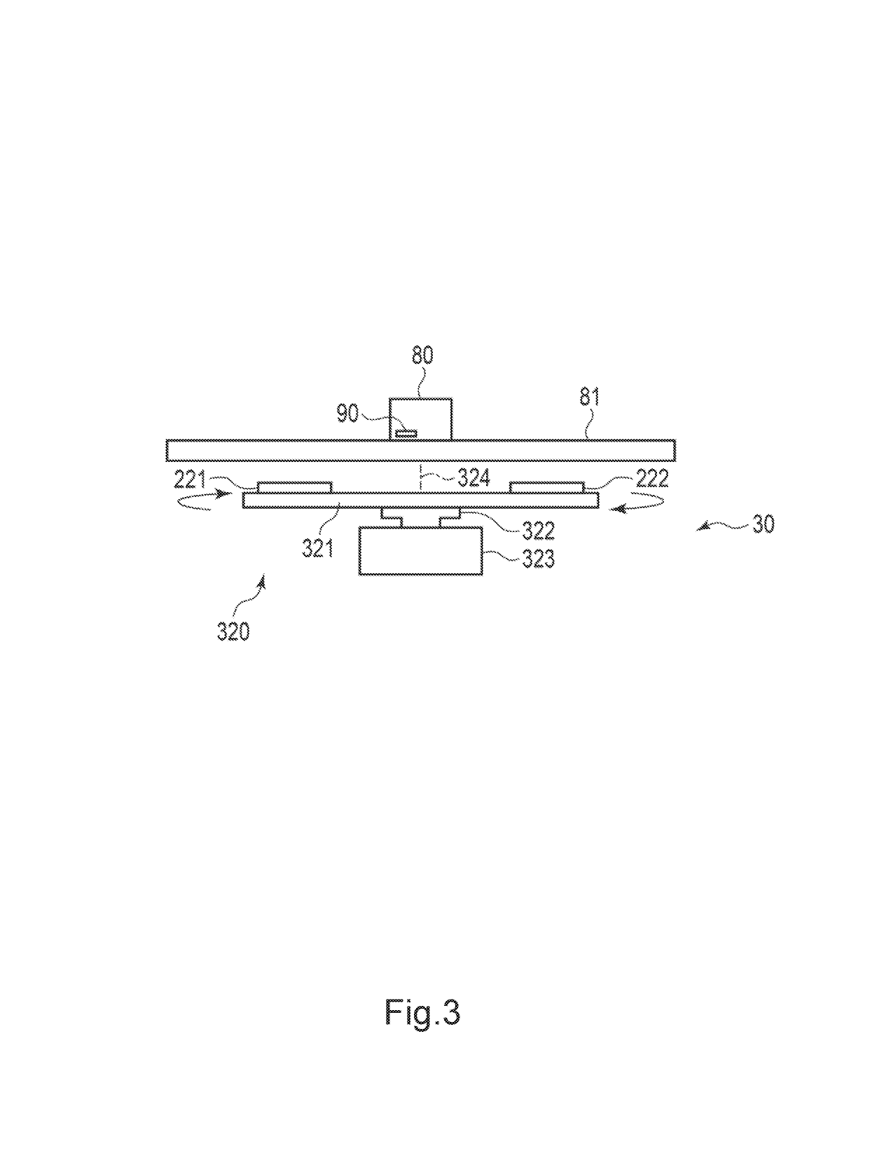

Subsequently, another configuration example of the relative position change device 30 will be described with reference to FIG. 3. FIG. 3 is a diagram showing another configuration example of the relative position change device 30 of the wireless tag communication apparatus 10.

In the configuration example of the relative position change device 30 shown in FIG. 3, the antenna 20 includes two antennas 221 and 222. The antennas 221 and 222 are installed below the table 81 on which the article 80 to which the wireless tag 90 is attached is placed.

The relative position change device 30 includes a moving mechanism 320 that causes the antennas 221 and 222 to move. The moving mechanism 320 is a rotating mechanism that causes the antennas 221 and 222 to move around a rotation center axis 324. The moving mechanism 320 includes a stage 321, a holding unit 322, and a driving device 323. The stage 321 holds the antennas 221 and 222. The holding unit 322 holds the stage 321 rotatably. The driving device 323 causes the holding unit 322 to rotate around the rotation center axis 324. For this reason, when the driving device 323 causes the holding unit 322 holding the stage 321 to rotate, the antennas 221 and 222 held by the stage 321 are caused to rotate and move around the rotation center axis 324.

The driving device 323 is controlled by the reading device 40. The driving device 323 is, for example, a stepping motor. The reading device 40 controls the change in relative positions of the antennas 221 and 222 to the wireless tag 90, i.e., rotational movement, by controlling the stepping motor that is the driving device 323.

### (Still another configuration example of relative position change device)

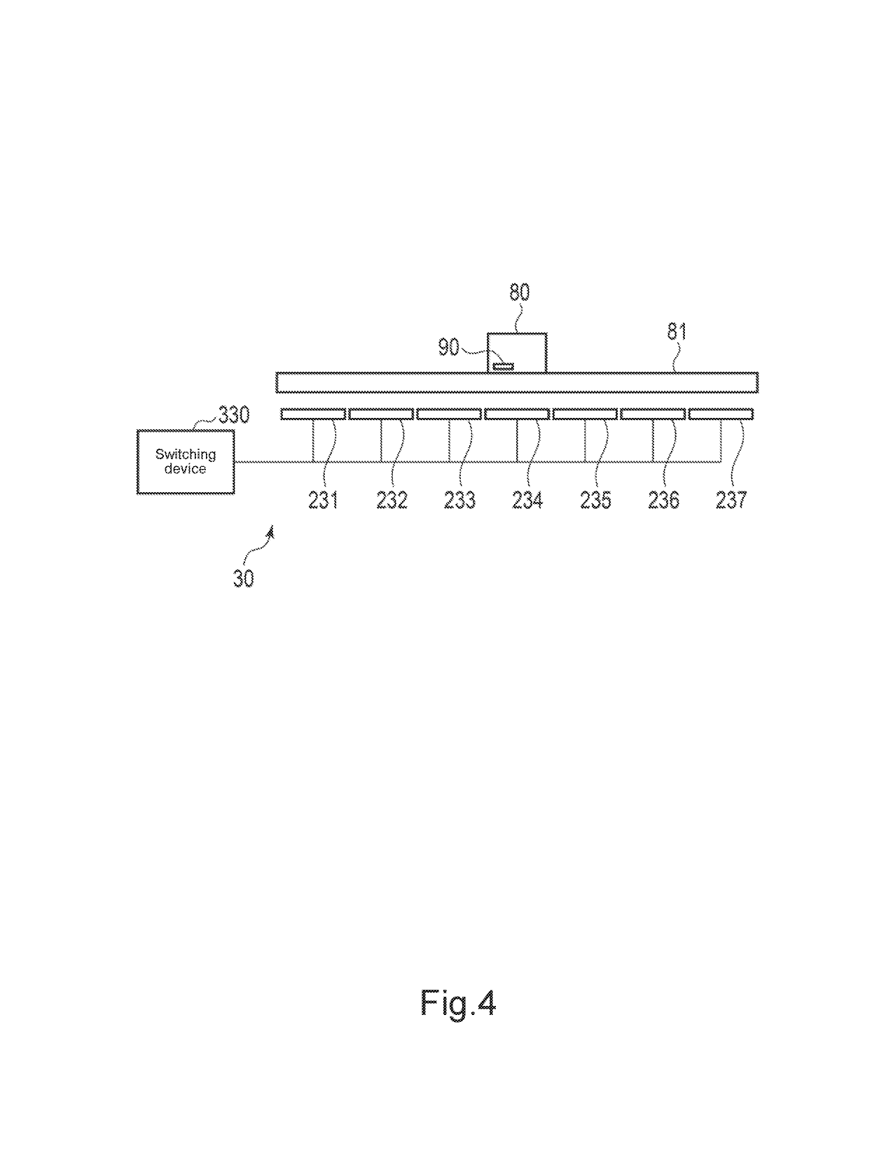

Next, still another configuration example of the relative position change device 30 will be described with reference to FIG. 4. FIG. 4 is a diagram showing still another configuration example of the relative position change device 30 of the wireless tag communication apparatus 10.

In the configuration example of the relative position change device 30 shown in FIG. 4, the antenna 20 includes a plurality of antennas, e.g., seven antennas 231 to 237. The antennas 231 to 237 are installed below the table 81 on which the article 80 to which the wireless tag 90 is attached is placed. The number of antennas 231 to 237 is not limited thereto and only needs to be more than one, but the larger the better.

The relative position change device 30 includes a switching device 330 that switches the antennas 231 to 237. For example, the switching device 330 switches the between on and off of the transmission function and the reception function of the antennas 231 to 237. That is, the switching device 330 is capable of transmitting and receiving radio waves using an arbitrary antenna of the antennas 231 to 237.

The switching device 330 is controlled by the reading device 40. For example, the reading device 40 transmits and receives radio waves using one of the antennas 231 to 237 at a time and controls the switching device 330 such that the antenna that transmits and receives radio waves is switched over time. For example, the reading device 40 controls the switching device 330 such that the antenna that transmits and receives radio waves is switched along the array of the antennas 231 to 237. The reading device 40 controls the change in relative positions of the antennas 231 to 237 to the wireless tag 90 by switching the antenna that transmits and receives radio waves.

### (Hardware configuration)

The reading device 40, the inferring device 50, the terminal 60, and the cross-check device 70 of the wireless tag communication apparatus 10 is configured by, for example, a computer. The computer includes, for example, a personal computer, a server computer, or a tablet.

In one example, the reading device 40, the inferring device 50, the terminal 60, and the cross-check device 70 are configured by one computer. The reading device 40, the inferring device 50, the terminal 60, and the cross-check device 70 may each be configured one computer. For example, the terminal 60 may be configured by one computer and may wirelessly communicate with another computer constituting the reading device 40, the inferring device 50, and the cross-check device 70.

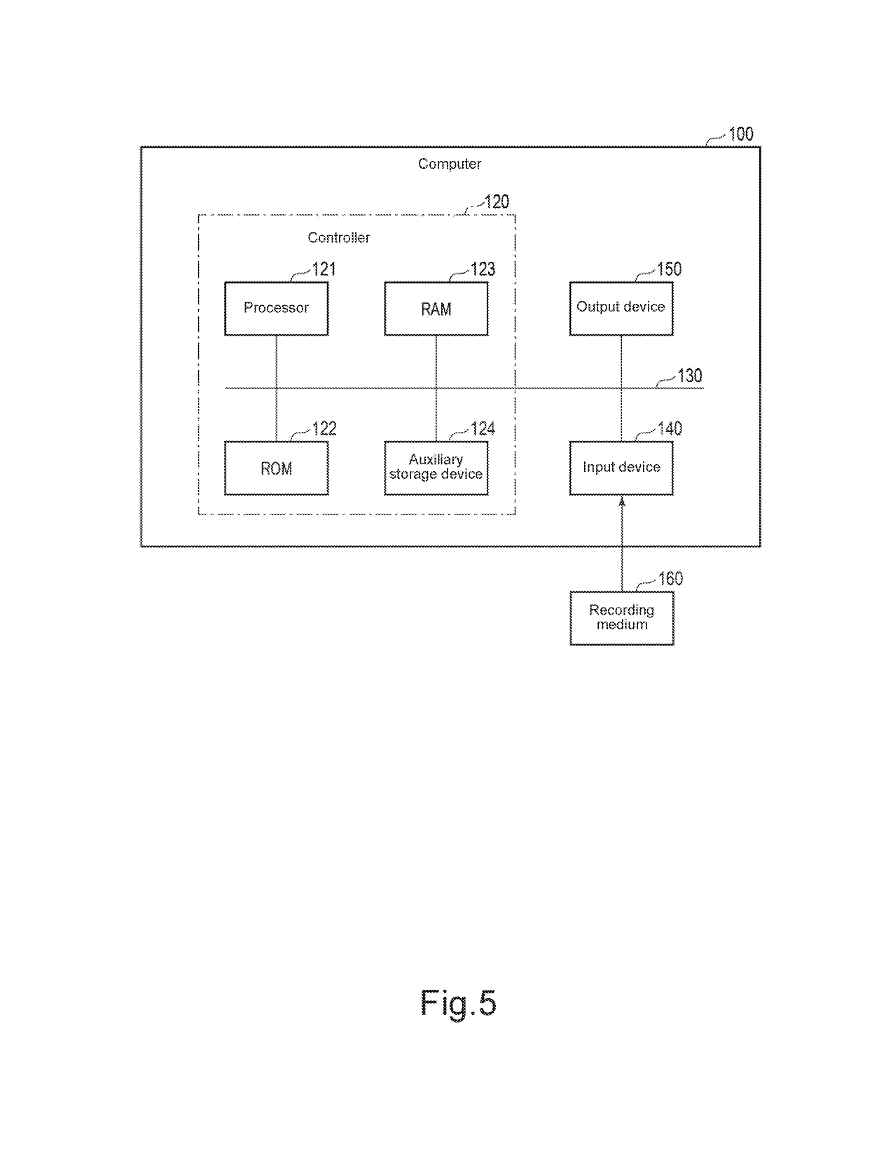

A hardware configuration example of a computer 100 constituting the reading device 40, the inferring device 50, the terminal 60, and the cross-check device 70 will be described with reference to FIG. 5. FIG. 5 is a block diagram showing a hardware configuration example of the computer 100 constituting the reading device 40, the inferring device 50, the terminal 60, and the cross-check device 70.

The computer 100 includes a controller 120, an input device 140, and an output device 150.

The controller 120 controls the entire computer 100. The controller 120 includes a processor 121, a read only memory (ROM) 122, a random access memory (RAM) 123, and an auxiliary storage device 124.

The processor 121, the ROM 122, the RAM 123, the auxiliary storage device 124, the input device 140, and the output device 150 are electrically connected to each other via a bus 130 and are capable of transmitting/receiving data to/from each other.

The processor 121 includes, for example, a general-purpose hardware processor including a central processing unit (CPU) and a graphical processing unit (GPU). The processor 121 executes the program developed into the RAM 123, thereby executing various functions of the computer 100.

The ROM 122 is a non-volatile memory constituting part of the main storage device. The ROM 122 non-temporarily stores the startup program necessary for starting up the computer 100. The processor 121 develops the startup program in the ROM 122 into the RAM 123 and executes the program, thereby starting up the computer 100. The ROM 122 includes, for example, an erasable programmable read only memory (EPROM) and is capable of storing various settings at the time of startup in addition to the startup program.

The RAM 123 is a volatile memory constituting part of the main storage device. The RAM 123 temporarily stores the program necessary for the processor 121 to process and data necessary for executing the program. That is, the RAM 123 functions as a work area of the processor 121.

The auxiliary storage device 124 includes a non-volatile memory such as a hard disk drive (HDD) and a solid state drive (SSD). The auxiliary storage device 124 is capable of non-temporarily storing various programs to be executed by the processor 121 and data necessary for executing the programs. The processor 121 develops the program in the auxiliary storage device 124 into the RAM 123 and executes the program, thereby executing various functions of the computer 100.

The input device 140 is a device for a user to input information and an instruction, and receives input of information and an instruction. The input device 140 includes a keyboard, a pointing device, and the like. The pointing device includes a mouse, a track pad, a touch screen, and the like. The input device 140 also includes a sensor. The sensor includes a position sensor, a camera, and the like. For example, in the case where the relative position change device 30 has the configuration example shown in FIG. 2 or FIG. 3, the position sensor includes a hope position sensor that detects that the antenna 211, 221, or 222 is at the initial position (home position).

The output device 150 is a device that outputs information to provide information to a user. The output device 150 is, for example, a display device and displays characters, images, and the like on a screen. For example, the output device 150 is a liquid crystal display, an organic EL display, a plasma display, or the like. The output device 150 is also, for example, a sound output device and includes a speaker or the like that outputs sound. The output device 150 is also, for example, a light-emitting device that reports abnormalities using light and includes various light-emitting devices such as LEDs.

The input device 140 and the output device 150 may be configured as an input/output device having both functions. Such an input/output device may include, for example, a touch panel display.

Further, the input device 140 may also include a device that captures information and data from the outside. For example, the input device 140 may include a wired or wireless interface or reception device.

Further, the output device 150 may also include a device that outputs information and data to the outside. For example, the output device 150 may include a wired or wireless interface or transmission device.

Further, the input device 140 may also include a device that reads data from a computer-readable recording medium 160 that has non-temporarily recorded data such as a program. For example, the recording medium 160 includes a disc such as a flexible disc, an optical disc (CD-ROM, CD-R, DVD-ROM, DVD-R, etc.), and a magneto-optical disc (MO, etc.), or a semiconductor memory. The input device 140 includes a drive, a reader, and the like therefor.

The program to be stored in the auxiliary storage device 124 is provided to the computer 100 via the recording medium 160, for example. Further, the program may be stored on a server on a network and downloaded to be provided to he computer 100.

For example, the processor 121 executes, when the computer 100 starts up, the startup program in the ROM 122 to start up the operating system (OS). The processor 121 monitors an instruction input, connection of an external device, and the like under the control of the OS. Further, the processor 121 sets a program area and a data area in the RAM 123 under the control of the OS.

In response to the instruction input to start up the program, the processor 121 reads the program from the auxiliary storage device 124 into the program area of the RAM 123 and reads the data necessary for executing the program from the auxiliary storage device 124 into the data area of the RAM 123. The processor 121 calculates the data in the data area in accordance with the program and write the calculation result to the data area.

By such an operation, the processor 121, the RAM 123, and the auxiliary storage device 124 cooperate to execute at least part of the function of the controller 120. Further, the controller 120, the input device 140, and the output device 150 cooperate to execute at least part of the function of the computer 100.

The program that is non-temporarily stored in the auxiliary storage device 124 includes a program for causing the processor 121 to execute at least part of the function of the controller 120. In other words, the processor 121 executes at least part of the function of the controller 120 by executing this program.

For example, the program that is non-temporarily stored in the auxiliary storage device 124 includes a wireless tag communication program that causes the computer 100 to execute at least part of the functions of the reading device 40, the inferring device 50, the terminal 60, and the cross-check device 70 of the wireless tag communication apparatus 10. When the processor 121 executes the wireless tag communication program, the controller 120 cooperate with the input device 140 and the output device 150 to execute at least part of the functions of the reading device 40, the inferring device 50, the terminal 60, and the cross-check device 70 of the wireless tag communication apparatus 10.

### (First operation example of wireless tag communication apparatus)

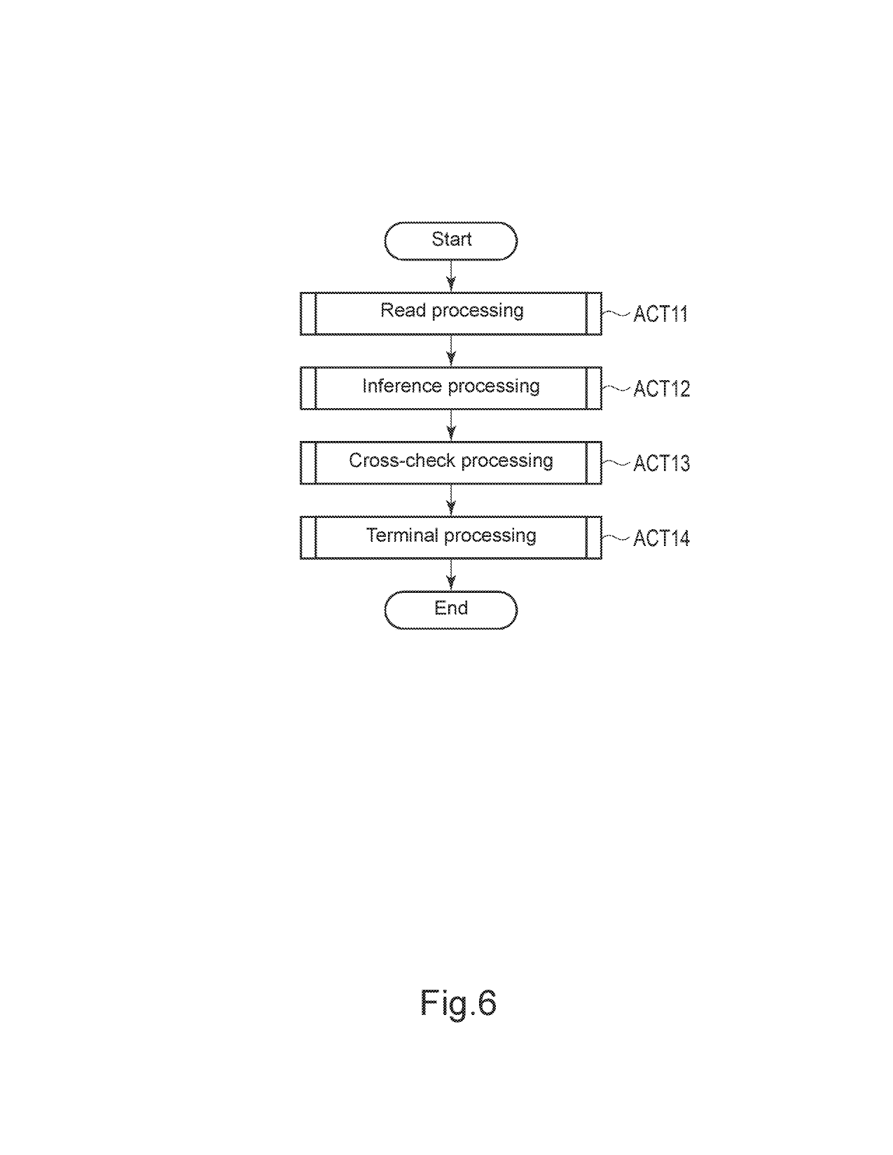

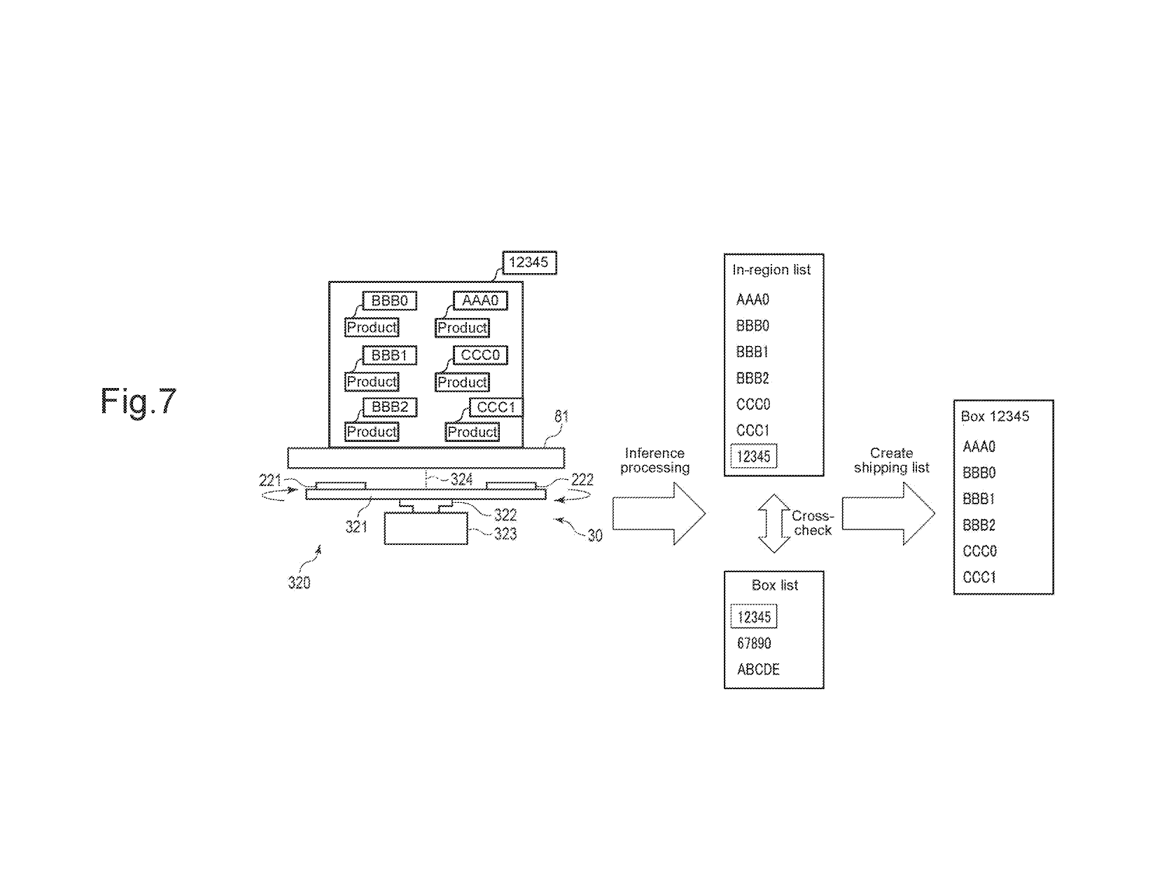

Next, a first operation example of the wireless tag communication apparatus 10 will be described with reference to FIG. 6 and FIG. 7. FIG. 6 is a flowchart showing a first operation example of the wireless tag communication apparatus 10. FIG. 7 is a diagram schematically showing an operation example of the wireless tag communication apparatus 10 shown in FIG. 6. The flowchart shown in FIG. 6 is started by, for example, inputting an operation start instruction to the terminal 60.

In ACT11, the reading device 40 performs read processing. The reading device 40 reads the tag data from the wireless tag 90 while the relative position change device 30 changes the relative position of the antenna 20 to the wireless tag 90. In this way, the reading device 40 reads tag data of the wireless tag 90 at a plurality of relative positions of the antenna 20 to the wireless tag 90. The reading device 40 transmits the read tag data of the wireless tag 90 to the inferring device 50.

In ACT12, the inferring device 50 performs inference processing. The inferring device 50 infers the disposed region of each wireless tag 90 from the tag data of the wireless tag 90 read by the reading device 40. For example, the inferring device 50 infers whether each wireless tag 90 is in the disposed region or outside the disposed region. The method of the inference will be described below. The inferring device 50 transmits the inference result to the cross-check device 70.

In ACT13, the cross-check device 70 performs cross-check processing. In this regard, for example, the cross-check device 70 creates an in-region list first, as shown in FIG. 7. The in-region list is a list of identification codes of the wireless tags 90 inferred to be in the disposed region by the inferring device 50. The phrase "in the disposed region" refers to being in the area where a target shipping box and a product put in the shipping box are disposed. Next, the cross-check device 70 checks each identification code of the wireless tag 90 in the in-region list against the box list given in advance to identify the shipping box in the disposed region. As described above, the box list is a list of identification codes of the wireless tags 90 attached to shipping boxes. Subsequently, the cross-check device 70 creates a shipping list. As described above, the shipping list is a list of the identification code of the wireless tag 90 attached to the identified shipping box and identification codes of the wireless tags 90 attached to the products put in the shipping box. After that, the cross-check device 70 transmits the shipping list to the terminal 60.

In ACT14, the terminal 60 performs terminal processing. For example, the terminal 60 displays the shipping list received from the cross-check device 70.

### (Operation example of read processing)

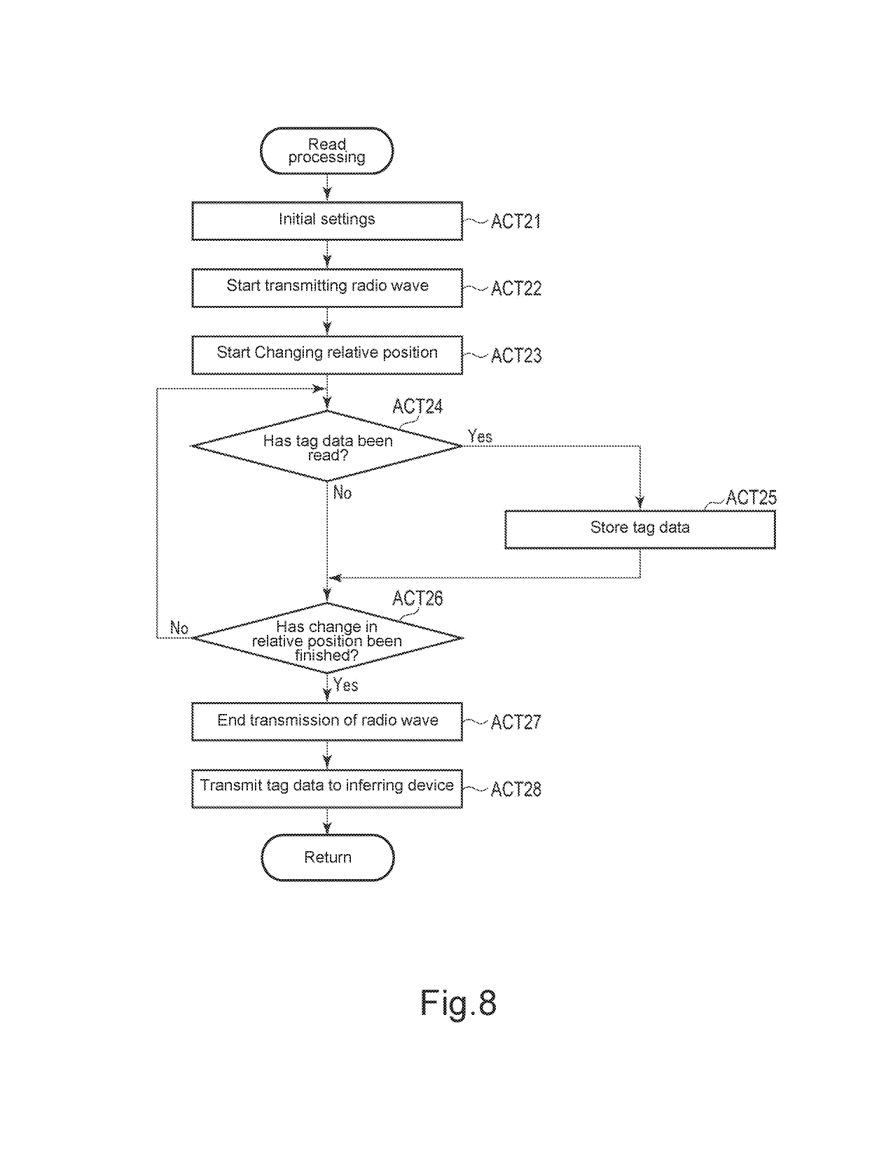

Next, an operation example of the read processing shown in FIG. 6 will be described with reference to FIG. 8. FIG. 8 is a flowchart showing an operation example of the read processing shown in FIG. 6.

First, the reading device 40 performs initial setting processing in ACT21 as necessary. For example, the initial setting processing includes processing of disposing the antenna 211, 221, or 222 at the initial position in the case where the relative position change device 30 has a configuration example of including, for example, the moving mechanism 310 that causes the antenna 211 to move as shown in FIG. 2 or the moving mechanism 320 that causes the antennas 221 and 222 to move as shown in FIG. 3.

Next, in ACT22, the reading device 40 starts transmitting a radio wave via the antenna 20. At this time, the reading device 40 transmits a radio wave with an output that ensures that the wireless tag 90 in the disposed region responds.

Subsequently, in ACT23, the relative position change device 30 changes the relative position of the antenna 20 to the wireless tag 90.

In the case where the tag data of the wireless tag 90 has been successfully read in ACT24 (Yes in ACT24), the reading device 40 stores the read tag data of the wireless tag 90 in ACT25.

After storing the tag data in the case where the tag data of the wireless tag 90 has been successfully read (Yes in ACT24), or in the case where the tag data of the wireless tag 90 has failed to be read (No in ACT24), the reading device 40 determines whether or not the change in relative position of the antenna 20 to the wireless tag 90 has been finished in ACT26 and repeatedly performs the processing of ACT24 and ACT25 until the change in relative position of the antenna 20 to the wireless tag 90 is finished (during No in ACT26).

When the change in relative position of the antenna 20 to the wireless tag 90 has been finished (in the case of Yes in ACT26), the reading device 40 ends the transmission of the radio wave in ACT27 and transmits the read tag data to the inferring device 50 in ACT28.

### (Operation example of inference processing)

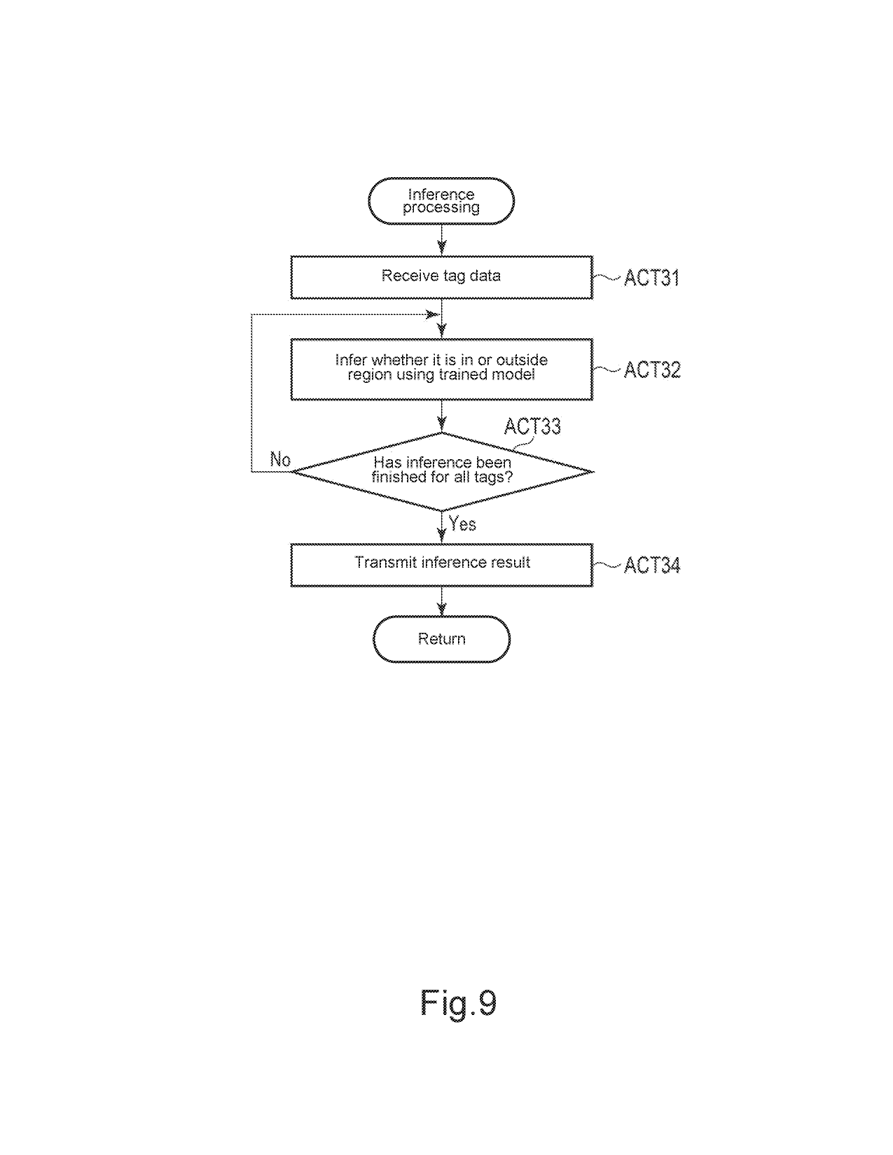

Next, an operation example of the inference processing shown in FIG. 6 will be described with reference to FIG. 9. FIG. 9 is a flowchart showing an operation example of the inference processing shown in FIG. 6. This operation example is an example in which whether the wireless tag 90 is in the disposed region or outside the disposed region is inferred using a trained model by machine learning.

In ACT31, the inferring device 50 receives the tag data of the wireless tag 90 from the reading device 40.

In ACT32, the inferring device 50 infers whether each wireless tag 90 is in the disposed region or outside the disposed region from the received tag data at a plurality of relative positions of each wireless tag 90 using a trained model by machine learning.

The inferring device 50 repeats the inference of ACT32 for all of the wireless tags 90 until the inference is finished (during No in ACT33).

When the inference is finished for all of the wireless tags 90 (in the case of Yes in ACT33), the inferring device 50 transmits the inference result to the cross-check device 70 in ACT34.

### (Another operation example of inference processing)

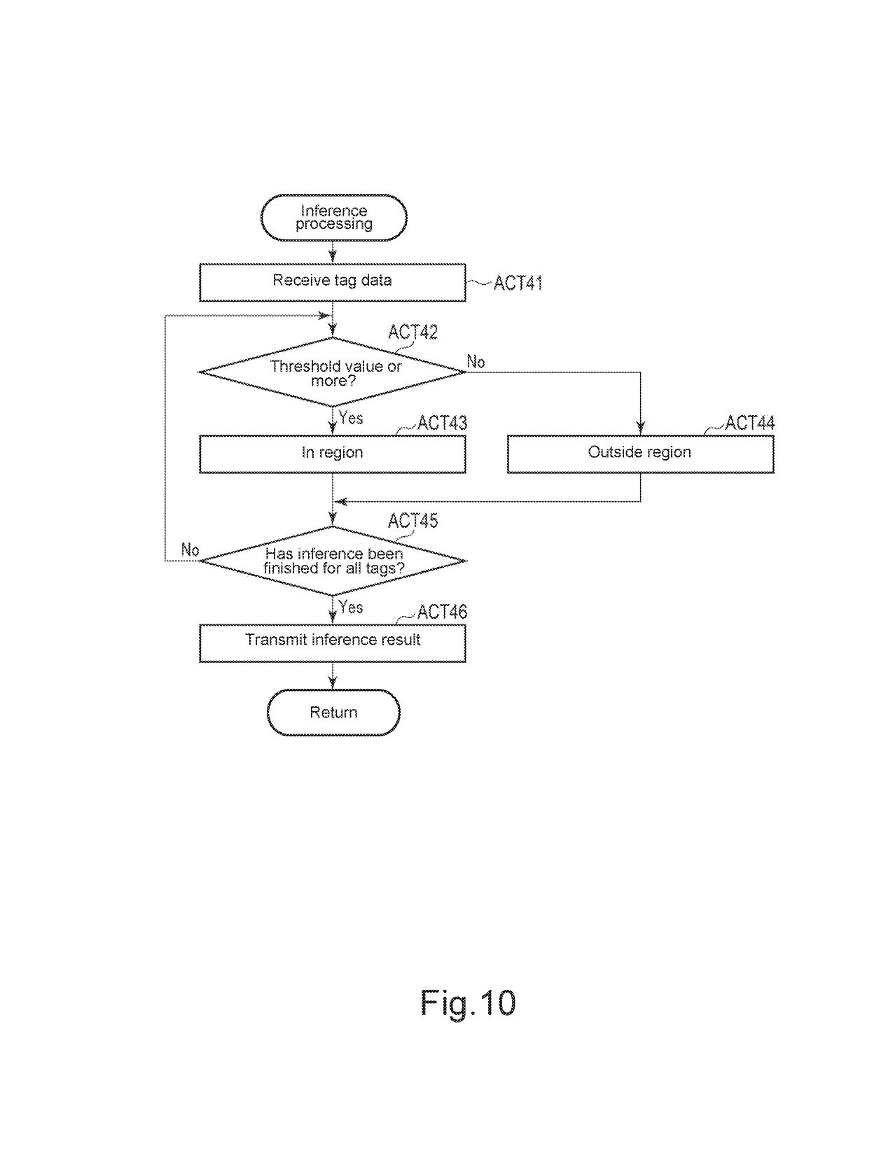

Next, another operation example of the inference processing shown in FIG. 6 will be described with reference to FIG. 10. FIG. 10 is a flowchart showing another operation example of the inference processing shown in FIG. 6. This operation example is an example in which whether the wireless tag 90 is in the disposed region or outside the disposed region is inferred on the basis of the phase difference of the radio wave received by the antenna 20.

In ACT41, the inferring device 50 receives the tag data of the wireless tag 90 from the reading device 40.

In ACT42, the inferring device 50 calculates a phase difference, which is a change in phase of the received tag data with respect to the change in relative position at a plurality of relative positions of each wireless tag 90, and determines whether or not the phase difference is a threshold value or more.

In the case where the phase difference is the threshold value or more (in the case of Yes in ACT42), the inferring device 50 infers that the wireless tag 90 is in the disposed region in ACT43.

On the contrary, in the case where the phase difference is less than the threshold value (in the case of No in ACT42), the inferring device 50 infers that the wireless tag 90 is outside the disposed region in ACT44.

The inferring device 50 repeats the inference of ACT42 to ACT44 until the inference is finished for all of the wireless tags 90 (during No in ACT45).

When the inference is finished for all of the wireless tags 90 (in the case of Yes in ACT45), the inferring device 50 transmits the inference result to the cross-check device 70 in ACT46.

### (Operation example of cross-check processing)

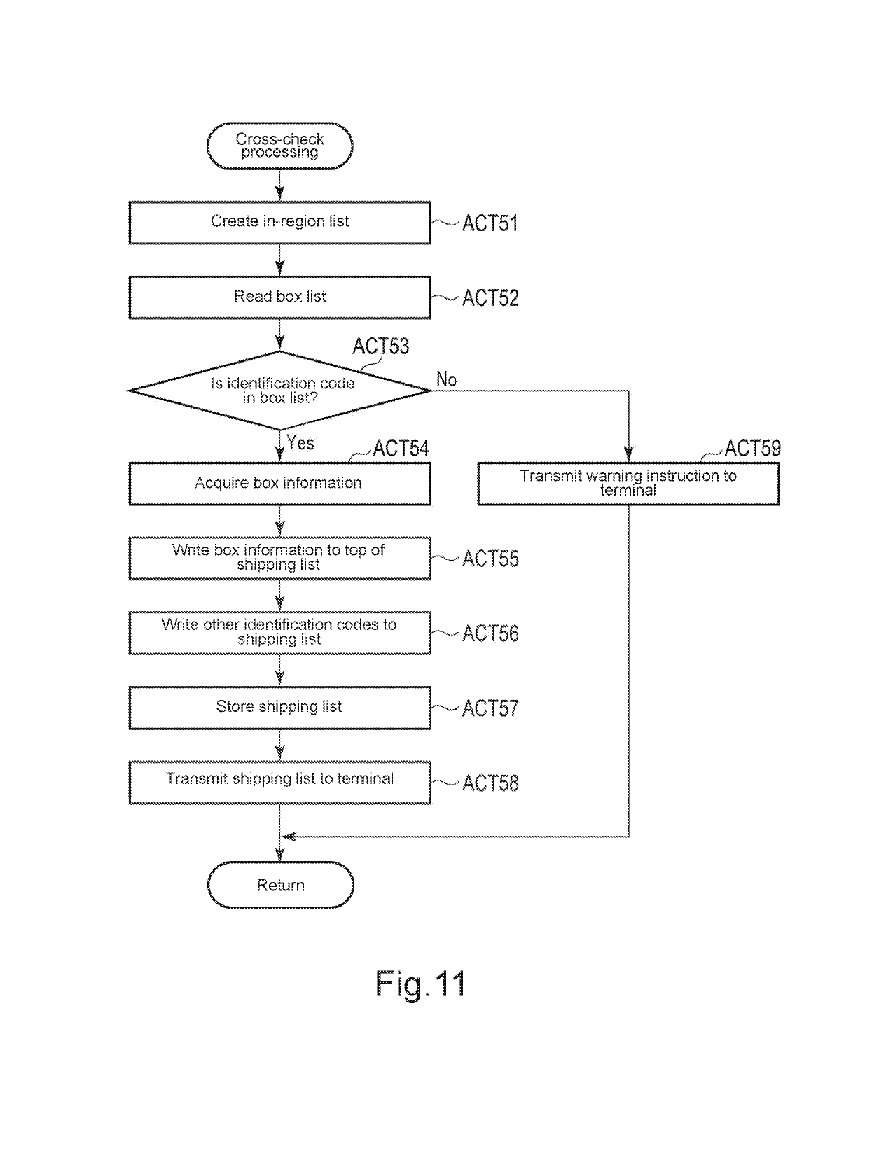

Next, an operation example of the cross-check processing shown in FIG. 6 will be described with reference to FIG. 11. FIG. 11 is a flowchart showing an operation example of the cross-check processing shown in FIG. 6.

First, in ACT51, the cross-check device 70 receives the inference result from the inferring device 50 and creates an in-region list on the basis of the inference result. As described above with reference to FIG. 7, the in-region list is a list of identification codes of the wireless tags 90 inferred to be in the disposed region by the inferring device 50.

Next, in ACT52, the cross-check device 70 reads a box list. As described above with reference to FIG. 7, the box list is a list of identification codes of the wireless tags 90 attached to shipping boxes. The box list is given to the cross-check device 70 in advance.

Subsequently, in ACT53, the cross-check device 70 checks each identification code of the wireless tag 90 in the in-region list against the box list to determine whether or not an identification code that matches the identification code of the wireless tag 90 in the in-region list is in the box list.

In the case where the result of the determination in ACT53 is that an identification code that matches the identification code of the wireless tag 90 in the in-region list is in the box list (in the case of Yes in ACT53), the cross-check device 70 identifies the shipping box of the identification code as the shipping box in the disposed region and acquires box information of the shipping box in ACT54. The box information is, for example, the identification code of the wireless tag 90 attached to the shipping box, and the identification code is used to identify, for example, the shipping destination.

In the example shown in FIG. 7, since the identification code "12345" in the in-region list matches the identification code "12345" in the box list, the shipping box that is in the disposed region is identified as the shipping box to which the wireless tag 90 with the identification code "12345" is attached.

In this case, the cross-check device 70 may delete the identification code that matches the identification code of the wireless tag 90 in the in-region list from the box list in order to speed up the subsequent cross-checking.

Next, in ACT55 and ACT56, the cross-check device 70 creates a shipping list. As described above, the shipping list is a list of the identification code of the wireless tag 90 attached to the identified shipping box and identification codes of the wireless tags 90 attached to the products put in the shipping box. In this example, the shipping list is a list of identification codes of the wireless tags inferred to be in the disposed region by the inferring device 50. For example, the shipping list is a list in which the identification code of the shipping box is placed at the beginning of the in-region list.

In order to create a shipping list, first, the cross-check device 70 writes the box information acquired in ACT54 to the top of the shipping list in ACT55. Next, in ACT56, the cross-check device 70 writes the other identification codes of the wireless tags 90 in the in-region list excluding the identification code of the wireless tag 90 that is the box information to the area after the box information at the top of the shipping list. In this way, the shipping list is completed.

The cross-check device 70 stores the completed shipping list in ACT57 and transmits the shipping list to the terminal 60 in ACT58.

In the case where the result of the determination in ACT53 is that an identification code that matches the identification code of the wireless tag 90 in the in-region list is not in the box list (in the case of No in ACT53), the cross-check device 70 transmits a warning instruction to the terminal 60 in ACT59. The warning instruction includes displaying a warning message indicating that the identification of a shipping box has failed, turning on an LED, making a warning sound, and the like.

Possible reasons for the fact that an identification code that matches the identification code of the wireless tag 90 in the in-region list is not in the box list includes the fact that no shipping box is in the disposed region, the fact that the wireless tag 90 is not attached to the shipping box, an inference error, and the like.

Although an example in which the cross-check device 70 transmits a warning instruction to the terminal 60 to cause the terminal 60 to issue a warning has been shown here, the cross-check device 70 may issue a warning instead of causing the terminal 60 to issue a warning.

### (Operation example of terminal processing)

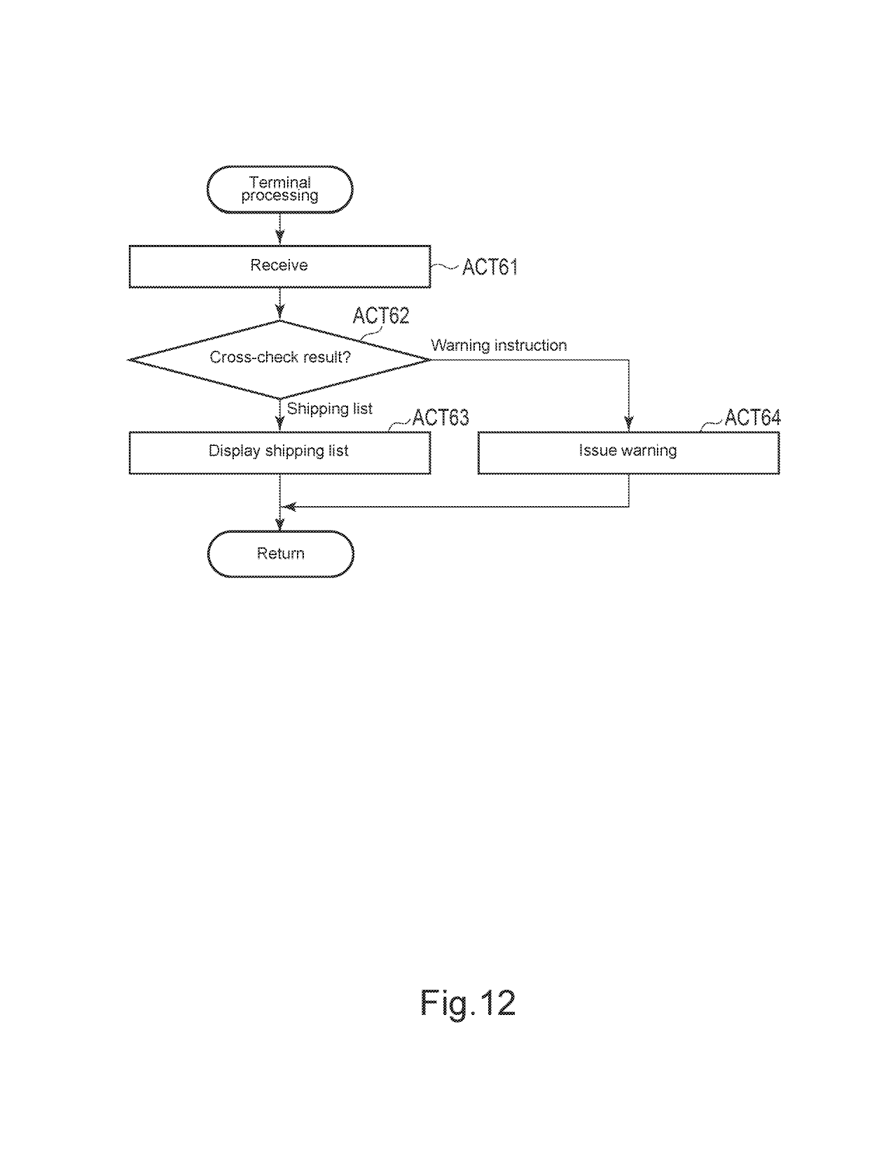

Next, an operation example of the terminal processing shown in FIG. 6 will be described with reference to FIG. 12. FIG. 12 is a flowchart showing an operation example of the terminal processing shown in FIG. 6.

First, in ACT61, the terminal 60 receives the cross-check result from the cross-check device 70. The cross-check result is a shipping list or a warning instruction.

Next, in ACT62, the terminal 60 determines whether the cross-check result received from the cross-check device 70 is a shipping list or a warning instruction.

In the case where the result of the determination in ACT62 is that a shipping list is received from the cross-check device 70 (in the case of a shipping list in ACT62), the terminal 60 displays the shipping list in ACT63.

In the case where the result of the determination in ACT62 is that a warning instruction is received from the cross-check device 70 (in the case of a warning instruction in ACT62), the terminal 60 issues the warning in ACT64.

### (Second operation example of wireless tag communication apparatus)

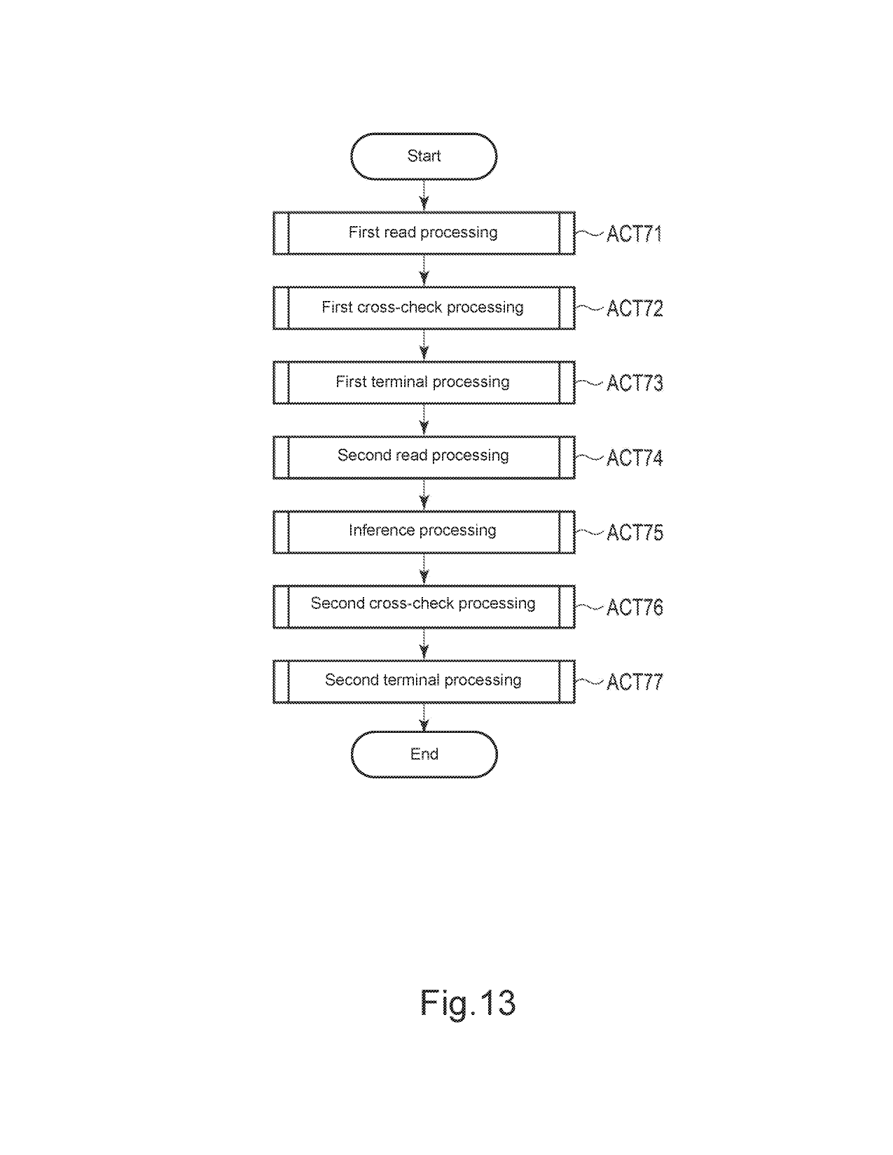

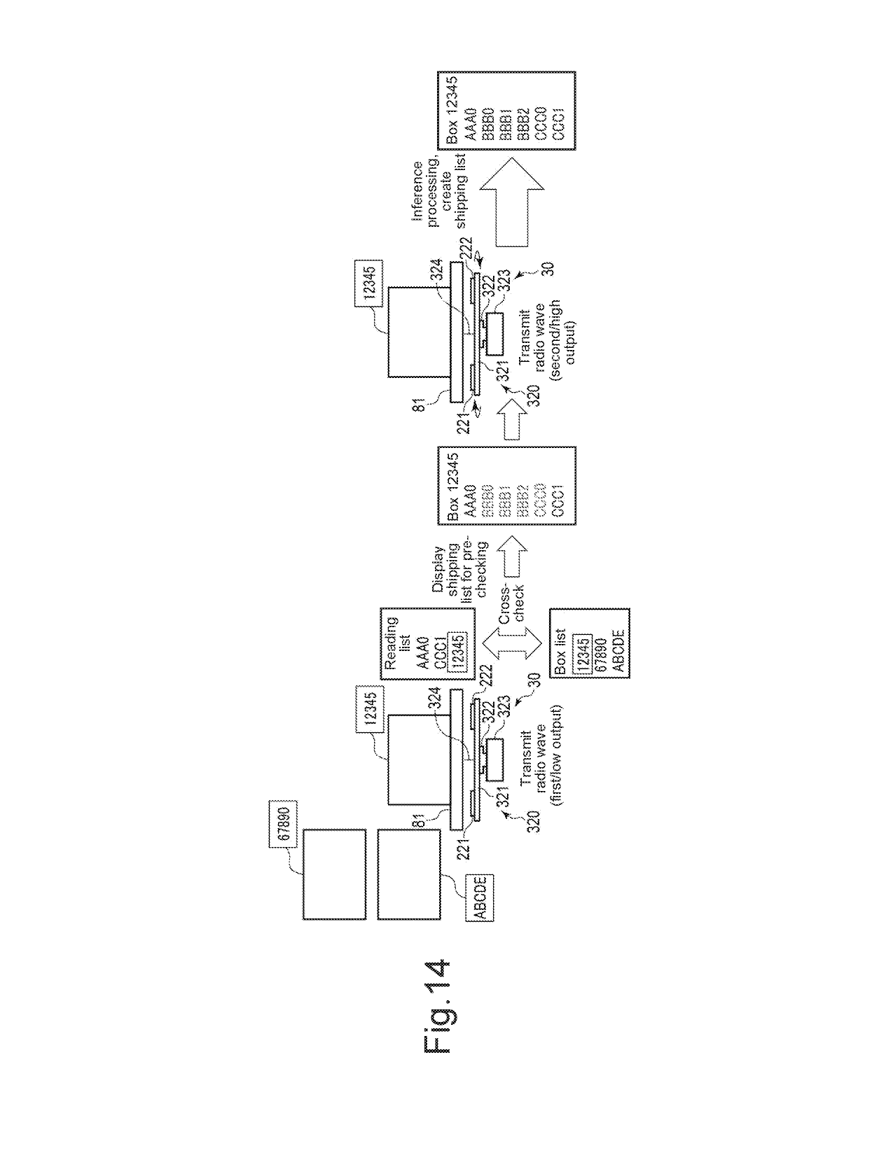

Next, a second operation example of the wireless tag communication apparatus 10 will be described with reference to FIG. 13 and FIG. 14. FIG. 13 is a flowchart showing a second operation example of the wireless tag communication apparatus 10. FIG. 14 is a diagram schematically showing an operation example of the wireless tag communication apparatus 10 shown in FIG. 13. The flowchart shown in FIG. 13 is started by inputting an operation start instruction to the terminal 60, for example.

In ACT71, the reading device 40 performs first read processing. In the first read processing, the relative position of the antenna 20 to the wireless tag 90 is not changed and the reading device 40 reads tag data from the wireless tag 90.

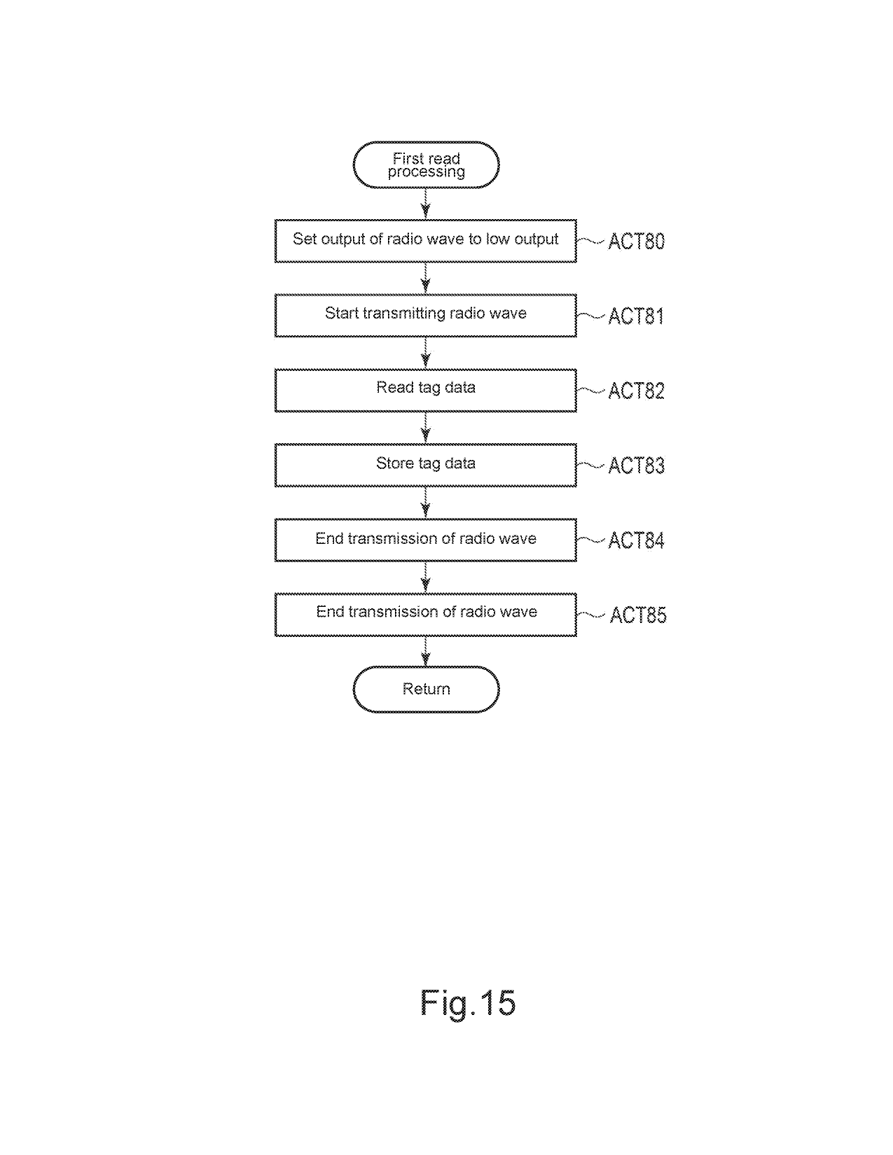

Now, the first read processing shown in FIG. 13 will be described with reference to FIG. 15. FIG. 15 is a flowchart showing an operation example of the first read processing shown in FIG. 13.

First, in ACT80, the reading device 40 sets the output of a radio wave to a low output. The radio wave of a low output means a radio wave of an output that allows the wireless tag 90 in the disposed region to respond but not the wireless tag 90 outside the disposed region cannot respond. In other words, the radio wave of a low output means a radio wave of an output that reliably causes the wireless tag 90 outside the disposed region not to respond.

For example, in the example shown in FIG. 14, the region on the table 81 is in the disposed region, the region outside the region on the table 81 is outside the disposed region, the wireless tag 90 with an identification code "12345" attached to the shipping box in the disposed region responds, but the wireless tags 90 with identification codes "67890" and "ABCDE" attached to the shipping boxes outside the disposed region do not respond. Further, all of the wireless tags 90 attached to the products put in the shipping box to which the wireless tag 90 with the identification code "12345" is attached do not necessarily respond. In FIG. 14, the illustration of the products put in the shipping box is omitted.

Next, the reading device 40 starts transmitting a radio wave via the antenna 20 in ACT81, reads the tag data of the wireless tag 90 in ACT82, and stores the read tag data of the wireless tag 90 in ACT82.

After that, the reading device 40 ends the transmission of a radio wave in ACT84 and transmits the read tag data to the cross-check device 70 in ACT85.

With reference to FIG. 13 again, in ACT72, the cross-check device 70 performs first cross-check processing. In the first cross-check processing, the cross-check device 70 checks each identification code of the wireless tag 90 read by the first read processing in ACT71 against the box list.

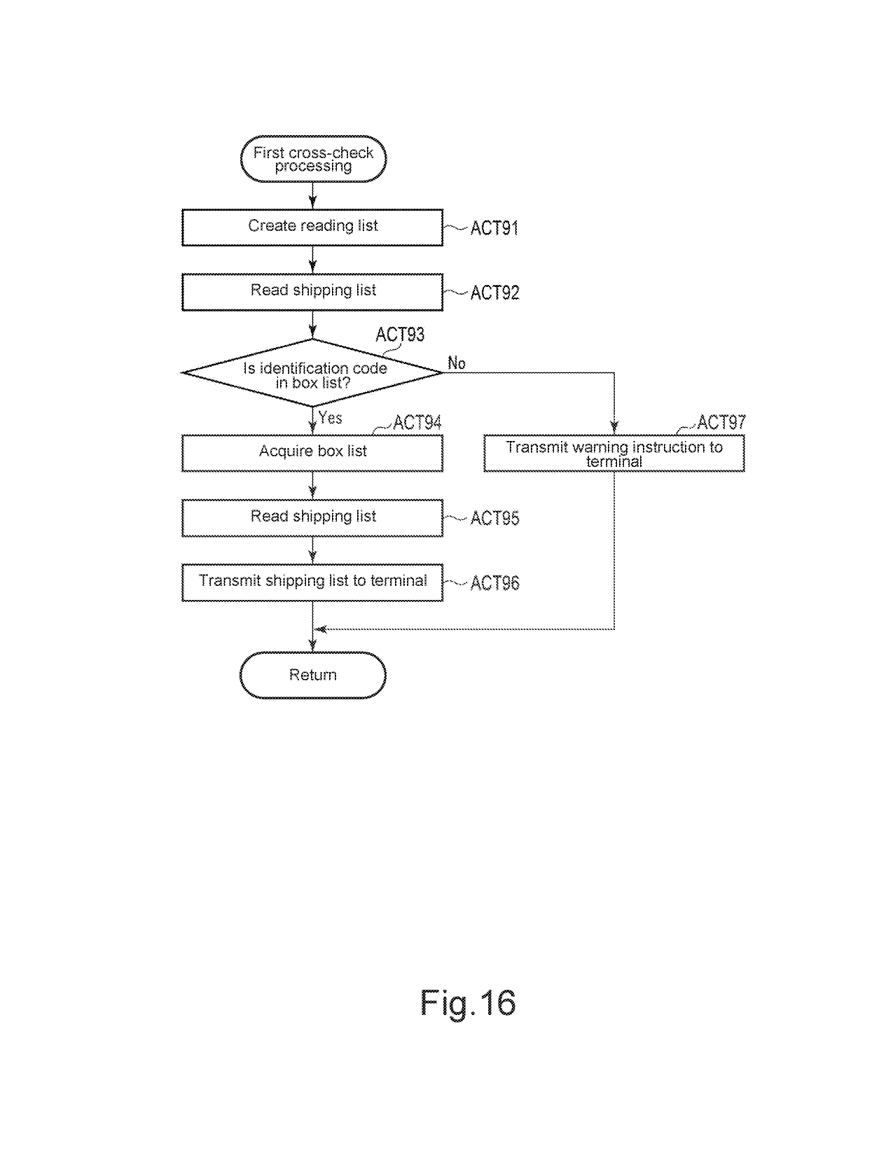

Now, the first cross-check processing shown in FIG. 13 will be described with reference to FIG. 16. FIG. 16 is a flowchart showing an operation example of the first cross-check processing shown in FIG. 13.

First, in ACT91, the cross-check device 70 receives the reading result from the reading device 40 and creates a reading list on the basis of the reading result, as shown in FIG. 14. The reading list is a list of identification codes of the wireless tags 90 read by the reading device 40.

Next, in ACT92, the cross-check device 70 reads a box list. As described above, the box list is a list of identification codes of the wireless tags 90 attached to shipping boxes.

Subsequently, in ACT93, the cross-check device 70 checks each identification code of the wireless tag 90 in the reading list against the box list to determine whether or not an identification code that matches the identification code of the wireless tag 90 in the reading list is in the box list.

In the case where the result of the determination in ACT93 is that an identification code that matches the identification code of the wireless tag 90 in the reading list is in the box list (in the case of Yes in ACT93), the cross-check device 70 identifies the shipping box with the identification code as the shipping box in the disposed region and acquires the box information of the shipping box in ACT94. The box information is, for example, the identification code of the wireless tag 90 attached to the shipping box.

In the example shown in FIG. 14, since the identification code "12345" in the reading list matches the identification code "12345" in the box list, the shipping box in the disposed region is identified as the shipping box to which the wireless tag 90 with the identification code "12345" is attached.

Subsequently, in ACT95, the cross-check device 70 reads a shipping list for pre-checking. The shipping list for pre-checking is given for each shipping box in advance. Each shipping list for pre-checking is a list of the identification code of the wireless tag 90 attached to the shipping box and identification codes of the wireless tags 90 attached to the products to be put in the shipping box.

In the example shown in FIG. 14, each shipping list for pre-checking includes identification codes "BBB0", "BBB1", "BBB2", and "CCC0" in addition to the identification codes in the reading list. These identification codes are identification codes of the wireless tags 90 attached to the products to be put in the shipping box and identification codes of the wireless tags 90, which have not been read by the reading device 40 in the first read processing (ACT71).

Next, in ACT96, the cross-check device 70 transmits the shipping list for pre-checking to the terminal 60.

In the case where the result of the determination in ACT93 is that an identification code that matches the identification code of the wireless tag 90 in the reading list is not in the box list (in the case of No in ACT92), the cross-check device 70 transmits a warning instruction to the terminal 60. The warning instruction includes displaying a warning message indicating that the identification of a shipping box has failed, turning on an LED, making a warning sound, and the like.

Possible reasons for the fact that an identification code that matches the identification code of the wireless tag 90 in the reading list is not in the box list includes the fact that no shipping box is in the disposed region, the fact that the wireless tag 90 is not attached to the shipping box, an insufficient output of the radio wave, and the like.

Although an example in which the cross-check device 70 transmits a warning instruction to the terminal 60 to cause the terminal 60 to issue a warning has been shown here, the cross-check device 70 may issue a warning instead of causing the terminal 60 to issue a warning.

With reference to FIG. 13 again, in ACT73, the terminal 60 performs first terminal processing. The details of the first terminal processing are the same as those of the terminal processing in the first operation example. For example, the terminal 60 displays the shipping list for pre-checking received from the cross-check device 70.

In the example shown in FIG. 14, of the identification codes of products to be shipped, identification codes "BBB0", "BBB1", "BBB2", and "CCC0" of the wireless tag 90, which have not been read in the first read processing (ACT71), are displayed in a different color, e.g., gray, for attention-getting purposes.

With reference to FIG. 13, in ACT74, the reading device 40 performs the second read processing. In the second read processing, the reading device 40 reads the tag data from the wireless tag 90 while the relative position change device 30 changes the relative position of the antenna 20 to the wireless tag 90. As a result, the reading device 40 reads the tag data of the wireless tag 90 at a plurality of relative positions of the antenna 20 to the wireless tag 90. The reading device 40 transmits the read tag data of the wireless tag 90 to the inferring device 50.

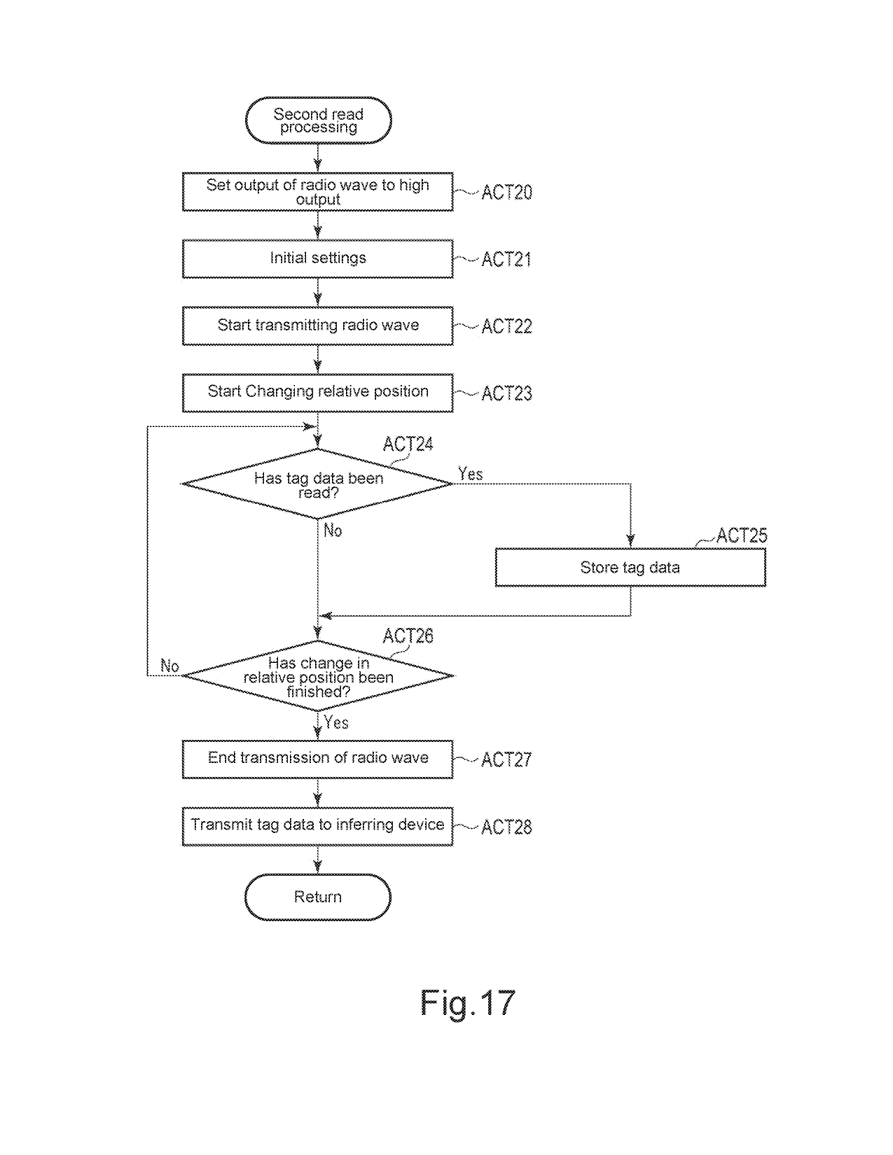

Now, the second read processing shown in FIG. 13 will be described with reference to FIG. 17. FIG. 17 is a flowchart showing an operation example of the second read processing shown in FIG. 13.

In ACT20, the reading device 40 sets the output of a radio wave to a high output. The radio wave of a high output means a radio wave of an output that reliably causes the wireless tag 90 in the disposed region to respond. For example, the output of a radio wave in the second read processing is the same as the output of a radio wave in the read processing in the first operation example.

For example, in the example shown in FIG. 14, the radio wave of a high output is a radio wave of an output that allows the wireless tag 90 with the identification code "12345" attached to the shipping box placed on the table 81 and all of the wireless tags 90 attached to the products put in the shipping box to respond.

In the second read processing, the reading device 40 reads the tag data from the wireless tag 90 while the relative position change device 30 changes the relative position of the antenna 20 to the wireless tag 90. In this way, the reading device 40 reads the tag data of the wireless tag 90 at a plurality of relative positions of the antenna 20 to the wireless tag 90. The processing of ACT21 and subsequent ACTs therefor are the same as the processing in the read processing in the first operation example. The reading device 40 transmits the read tag data of the wireless tag 90 to the inferring device 50.

With reference to FIG. 13 again, in ACT75, the inferring device 50 performs inference processing. The details of the inference processing are the same as those of the inference processing in the first operation example. For example, the inferring device 50 infers whether each wireless tag 90 is in the disposed region or outside the disposed region and transmits the inference result to the cross-check device 70.

In ACT76, the cross-check device 70 performs second cross-check processing. The details of the second cross-check processing are the same as those of the cross-check processing in the first operation example. For example, the cross-check device 70 creates an in-region list, checks the in-region list against a box list to identify the shipping box in the disposed region, creates a shipping list, and transmits the shipping list to the terminal 60.

In ACT77, the terminal 60 performs terminal processing. The details of the second terminal processing are the same as those of the terminal processing in the first operation example. For example, the terminal 60 receives and displays the shipping list created by the cross-check device 70.

### (Effects)

The wireless tag communication apparatus 10 according to the embodiment reads, by the reading device 40, tag data of the wireless tag 90 at a plurality of relative positions of the antenna 20 to the wireless tag 90, infers, by the inferring device 50, whether or not each wireless tag 90 is in a disposed region, identifies, by the cross-check device 70, a shipping box in the disposed region, and creates a shipping list that is a list of the shipping box and products therein. Therefore, according to the wireless tag communication apparatus 10, a shipping list is automatically created.

In the first operation example, since the shipping list is created in the single read processing at one time, the required time is short.

In the second operation example, the shipping list for pre-checking is displayed prior to the creation of a shipping list. This makes it easier for the user to quickly notice errors in items to be shipped (shipping boxes and products) and products that have been forgotten to be put, before the shipping list is created.

The program according to this embodiment may be transferred while being stored in an electronic apparatus or may be transferred while being not stored in an electronic apparatus. In the latter case, the program may be transferred via a network or may be transferred while being stored in a storage medium. The storage medium is a non-temporary tangible medium. The storage medium is a computer-readable medium. The storage medium only needs to be a medium that is capable of storing a program and can be read by a computer, such as a CD-ROM and a memory card, and its form is not limited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless tag communication apparatus, comprising:
an antenna configured to receive a radio wave transmitted from a wireless tag;
a reading device configured to read, on a basis of the radio wave received by the antenna, tag data including an identification code of the wireless tag; and
a cross-check device configured to check the identification code of the wireless tag read by the reading device against a box list that is a list of identification codes of wireless tags attached to shipping boxes to identify a shipping box to which the wireless tag read by the reading device is attached, and
create a shipping list that is a list of the identification code of the wireless tag attached to the identified shipping box and identification codes of wireless tags attached to articles put in the shipping box.

2. The wireless tag communication apparatus according to claim 1, further comprising:
a relative position change device configured to change a relative position of the antenna to the wireless tag; and
an inferring device configured to infer whether the wireless tag is in a disposed region from the tag data of the wireless tag at a plurality of relative positions of the antenna to the wireless tag.

3. The wireless tag communication apparatus according to claim 2, wherein
the cross-check device is further configured to check the identification code of the wireless tag inferred to be in the disposed region against the box list to identify the shipping box, and creates, as the shipping list,
a list of identification codes of wireless tags inferred to be in the disposed region.

4. The wireless tag communication apparatus according to claim 3, wherein
the inferring device is further configured to perform the inference using a trained model by machine learning.

5. The wireless tag communication apparatus according to claim 4, wherein
the cross-check device is further configured to delete, from the box list, the identification code of the wireless tag that matches the identification code of the wireless tag inferred to be in the disposed region.

6. The wireless tag communication apparatus according to claim 3, wherein
the reading device is further configured to read the tag data of the wireless tag while the relative position of the antenna to the wireless tag is constant.

7. The wireless tag communication apparatus according to claim 6, wherein
the cross-check device is further configured to check the identification code of the wireless tag read by the reading device against the box list to identify the shipping box to which the wireless tag read by the reading device, and select a shipping list of the identified shipping box from a plurality of shipping lists of shipping boxes held in advance.

8. The wireless tag communication apparatus according to claim 3, further comprising
a terminal configured to display the shipping list selected by the cross-check device.

9. The wireless tag communication apparatus according to claim 1, wherein
the cross-check device is further configured to perform warning processing where the identification of the shipping box has failed.

10. A wireless tag communication method, comprising:
receiving, by an antenna, a radio wave transmitted from a wireless tag;
reading, by a reading device, on a basis of the radio wave received by the antenna, tag data including an identification code of the wireless tag; and
checking the identification code of the wireless tag read by the reading device against a box list that is a list of identification codes of wireless tags attached to shipping boxes to identify a shipping box to which the wireless tag read by the reading device is attached; and
creating a shipping list that is a list of the identification code of the wireless tag attached to the identified shipping box and identification codes of wireless tags attached to articles put in the shipping box.
